(19) United States
(12) Patent Application Publication
(10) Pub. No.: US 2009/0119412 A1
(43) Pub. Date: May 7, 2009

(54) Support for avoidance of unnecessary tunneling

(75) Inventors: Markku Ala-Vannesluoma, Kargasala (FI); Basavaraj Patil, Coppell, TX (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 11/979,506

(22) Filed: Nov. 5, 2007

(51) Int. Cl. G06F 15/173

(52) U.S. Cl. 709/238

(57) ABSTRACT

A system can include an access router and a proxy mobile internet protocol aware client mobile internet protocol node. The access router can include a storage unit configured to store a local care-of-address. The access router can also include a sending unit configured to send the proxy mobile internet protocol aware client mobile internet protocol node the local care-of-address. The proxy mobile internet protocol aware client mobile internet protocol node can include a receiving unit configured to receive local care-of-address from an access router. The proxy mobile internet protocol aware client mobile internet protocol node can also include a processing unit configured to process the local care-of-address.

### CROSS REFERENCE TO RELATED APPLICATIONS

There are no applications that are related to this application.

### BACKGROUND OF THE INVENTION

1. Field of the Invention

Certain embodiments of the present invention generally relate to Internet Protocol (IP) mobility. For example, certain embodiments of the present invention relate to IP mobility associated with Proxy Mobile IP version 6 (PMIPv6). A way of, for example, avoiding unnecessary tunneling in a network that supports both PMIP and Client Mobile IP (CMIP) is provided.

2. Description of the Related Art

The idea of PMIP is to provide IP mobility to Mobile Nodes (MNs) without the need of having any IP mobility specific implementation in the MN. This implies that the IP layer functionality must be identical with the basic IPv6 MN-Access Router (AR) interface. In networks that utilize the concept of network based mobility management, e.g. PMIPv6, the option for the MN to use client based mobility management is usually also allowed.

When both CMIP and PMIP are to be supported in the network, depending on the configuration, the CMIP and PMIP home domain may be the same as or different from one another. If the CMIP home prefix is the same as the PMIP home prefix, the CMIP client running on the MN may think that the CMIP client is at home and so may not cause any signaling to the Home Agent (HA). Even in this case the MN may wish to use CMIP for tunneling data between MN and HA. If the PMIP and CMIP home prefixes are different, the CMIP client starts signaling to the HA to update its current location (PMIP home prefix). This causes two tunnels to be created: a PMIP tunnel between the AR and the HA and a CMIP tunnel between MN and HA. This double tunneling can lead to inefficient IP packet routing. One IP flow will have to be processed by both the PMIP HA and the CMIP HA.

### SUMMARY OF THE INVENTION

An embodiment of the present invention can be an apparatus. The apparatus can include a storage unit configured to store a local care-of-address. The apparatus can also include a sending unit configured to send a proxy mobile internet protocol aware client mobile internet protocol node the local care-of-address.

Another embodiment of the present invention can also be an apparatus. The apparatus can include a receiving unit configured to receive a local care-of-address from an access router. The apparatus can also include a processing unit configured to process the local care-of-address.

A further embodiment of the present invention can be a method. The method can include storing a local care-of-address. The method can further include sending a proxy mobile internet protocol aware client mobile internet protocol node the local care-of-address.

An additionally embodiment of the present invention can also be a method. The method can include receiving a local care-of-address from an access router. The method can also include processing the local care-of-address.

A system according to an embodiment of the present invention can include an access router and a proxy mobile internet protocol aware client mobile internet protocol node. The access router can include a storage unit configured to store a local care-of-address. The access router can also include a sending unit configured to send the proxy mobile internet protocol aware client mobile internet protocol node the local care-of-address. The proxy mobile internet protocol aware client mobile internet protocol node can include a receiving unit configured to receive local care-of-address from an access router. The proxy mobile internet protocol aware client mobile internet protocol node can also include a processing unit configured to process the local care-of-address.

Another embodiment of the present invention can be an apparatus that includes storage means for storing a local care-of-address. The apparatus can also include sending means for sending a proxy mobile internet protocol aware client mobile internet protocol node the local care-of-address.

A further embodiment of the present invention can be an apparatus that includes receiving means for receiving a local care-of-address from an access router. The apparatus can also include processing means for processing the local care-of-address.

An additional embodiment of the present invention can be a A computer program embodied on a computer-readable medium encoding instructions for performing storing a local care-of-address. The instructions can also be for performing sending a proxy mobile internet protocol aware client mobile internet protocol node the local care-of-address.

Another embodiment of the present invention can be a computer program embodied on a computer-readable medium encoding instructions for performing receiving a local care-of-address from an access router. The instructions can also be for performing processing the local care-of-address.

### BRIEF DESCRIPTION OF THE DRAWINGS

For proper understanding of the invention, reference should be made to the accompanying drawings, wherein:

FIG. 1 illustrates a system according to an embodiment of the present invention; and

FIG. 2 illustrates a method according to an embodiment of the present invention.

### DETAILED DESCRIPTION OF THE PREFERRED EMBODIMENT(S)

Certain embodiments of the present invention relate to CMIPv6/PMIPv6 mode selection, and more generally to IP mobility (PMIPv6). Certain embodiments of the present invention provide a way to avoid unnecessary tunneling in a network that supports both PMIP and CMIP. In general, this can be accomplished by the Access Router (AR) telling a PMIP-aware CMIP node the local care-of-address that can be used in CMIP registration in the Router Advertisement (RA). In that way, the PMIP-aware CMIP node can now configure the Care-of-Address (CoA) from the local address and thus avoid the need for double tunneling in the network.

When both CMIP and PMIP are to be supported in the network, depending on the configuration, the CMIP and PMIP home domain may be the same or different. If the CMIP home prefix is the same as the PMIP home prefix, the CMIP client running on the MN may think that the CMIP client is at home and so may not cause any signaling to the HA. Even in this case the MN may wish to use CMIP for tunneling data between MN and HA. If the PMIP and CMIP home prefixes are different, the CMIP client starts signaling to the HA to update its current location (PMIP home prefix). This causes two tunnels to be created: a PMIP tunnel between the AR and the HA and a CMIP tunnel between MN and HA. This double tunneling can lead to inefficient IP packet routing. One IP flow will have to be processed by both the PMIP HA and the CMIP HA.

The AR can explicitly tell a CMIP node that is PMIP-aware the local care-of address that can be used for CMIP registration in the Router Advertisement. The RA could contain a prefix information option for the PMIP prefix and an additional prefix information option for the AR local CoA. A new PMIP prefix information option type could be defined to avoid ordinary IPv6 nodes processing both prefix options. The structure could be identical to the prefix information option defined in RFC2462.

The PMIP-aware CMIP node can now configure the CoA from the local address and thus avoid the need for double tunneling in the network and the need to engage both PMIP HA and CMIP HA to data path.

The AR in the PMIP network can add a new “PMIP prefix information option” to the Router advertisements it sends. A new option type can be included to avoid ordinary IPv6 hosts from configuring an IPv6 address from the PMIP local prefix. So the structure of the option could be in some ways similar to those previously proposed but a new type value could be assigned. The receiving node can skip any options it doesn't identify. The PMIP-aware CMIP terminal may discard the normal prefix information option if it chooses to use the PMIP local prefix (alternatively, the terminal could configure both prefixes, but could set a higher priority for the local Care-of-Address (CoA) if it chooses CMIP). To ease the processing, the “PMIP prefix information option” can be placed as the first prefix information option in the RA.

Such embodiments can optimize the use of CMIP in PMIP networks by removing the need for double tunneling and multiple Home Agents (HAs) in the data path.

The mechanisms for allowing efficient usage of PMIP and CMIP simultaneously in the network may be needed for WiMAX rel 1.5 and also may be needed for Third Generation Partnership Project Release 8 (3GPP rel8).

Proxy Mobile IPv6 is a network-based mobility management protocol in which the host is not involved in any signaling to enable IP mobility as it moves and changes its point of attachment. This feature complements the mobility protocols such as Mobile IPv6 in which the host is involved in mobility management. On the other hand, nodes that are able to engage in mobility management themselves (i.e., able to implement the MIP6 functionality in the IP stack) might not require such kind of service.

PMIP6 protocol as currently specified is applicable within the scope of a single PMIP6 domain. However, deployment scenarios may include a broader scope than a single domain. Scenarios in which mobility is managed by the network are usually referred to as running in Proxy MIP (PMIP) mode. Analogously, when mobile nodes manage mobility themselves, this may be described as host-based mobility. There are several scenarios in which host-based Mobile IP and proxy MIP support co-exist in the same network. For example, a first scenario is one in which different mobility modes exist within a single PMIP6 domain. In the case of nomadic users, the network may need to provide mobility services simultaneously for nodes with and without the built-in mobility support. Each mobility mode, either PMIP6 or host-based MIP6, needs to be individually recognized and appropriately handled by the network.

A second scenario is one in which there is session continuation across different domains. In this case, a mobile node roaming in/out of the PMIP6 domain can aim to continue the ongoing session either retaining or substituting the assigned mobility mode. For example, an MN running a MIP6 session in the network can move to a PMIP6-enabled domain. Depending on the privileges and policies, the session is either continued using host-based mobility, or the network takes over the mobility management and begins handling the MN in the PMIP6 mode.

Existing IPv6 mechanisms, such as Neighbor Discovery protocol (NDP) or DHCPv6, may be insufficient for the purpose of mobility mode detection or capability negotiation. The present application, however, discusses means by which the network can indicate its PMIP6 capabilities and provide specific configuration parameters to mobile nodes. The proposal also proposes a method where MN can proactively participate in mobility management mode selection.

It is important to recognize that a PMIP6 prefix is a prefix assigned to the MN while the MN is residing within the PMIP6 domain. Depending on the mobility scope, this prefix can be assigned either by the Local Mobility Agent (LMA), or the HA. Likewise, an on-link prefix can refer to an IPv6 prefix available for address autoconfiguration in the local domain, for example valid within a scope of a single AR/Mobile Access Gateway (MAG).

In the PMIP6 domain MN may use stateless address autoconfiguration (SLAAC) or DHCPv6 to configure its addresses. The address configuration parameters provided to the MN may be different when supporting PMIP6 or host-based MIP6. If PMIP is used as a mechanism for global mobility or formulating the home link to the MN, the network can obtain the home prefix for the MN and can provide the same to the MN. The prefix can be assigned to the MN for the entire session, and can be consistently advertised throughout the entire PMIP6 domain.

For MIP6 capable nodes it can be sufficient to supply any globally routable local prefix (address) that MN will use to configure the care-of address (CoA) on its interface. The AR or MAG in an access network can be enabled to interpret the mobility preference of the host, in case such information is provided in router solicitation (RS) or a DHCP request. NDP and DHCP messages may be unable to serve as specific PMIP6 mobility triggers.

Furthermore, the profile associated with a user in Authentication, Authorization, and Accounting (AAA) may not really be useful as an indication about the mobility protocol for the hosts as the device and capability may change. For example, information that a subscriber is allowed PMIP6 does not provide indication on what kind of terminal the subscriber is actually using (for example, whether the terminal implements MIP6), or whether the MN would rather engage the host-based mobility if the MN is able to.

Explicit mechanisms and protocol extensions can be provided to enable the access network to advertise the PMIP6 feature and support to the hosts, provide the host with more reliable parameters allowing it to choose the mobility protocol based on its capabilities or other criteria, and allow MNs to signal their mobility mode preferences.

Thus, the present application provides some extensions to the Neighbor Discovery Protocol (NDP) and Dynamic Host Configuration Protocol (DHCP) (or similar protocols) that may serve as triggers for PMIP6 mobility selection. These extensions can include: a new indication flag in the RA, new options for the Router Advertisement and Router Solicitation messages, as well as new options for the related DHCP messages.

The AR can use a new option to expand the flags field in the Router Advertisement (RA) messages. If the access network does support PMIP6, the new option can be used to explicitly indicate this capability. By setting the “N” flag in the RA flag expansion option, the AR can advertise support for network-based mobility management, i.e., PMIP6 capability.

TABLE 1
RA flag expansion option with a PMIP6 indication

0 1 2 3
0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+
| Type | Length |N| Bit fields available . .
+−+−+−+−+−+−+−+−+−+−+−+−+−+−+−+−+−+−+−+−+−+−+−+−+−+−+−+−+−+−+−+−+
. . . for assignment |
+−+−+−+−+−+−+−+−+−+−+−+−+−+−+−+−+−+−+−+−+−+−+−+−+−+−+−+−+−+−+−+−+

As shown in Table 1, the “Type” field can be an 8-bit identifier of the option type to be assigned. The “Length” field can equal 1. The length can be checked when processing the option in order to allow for future expansion of this option if the need arises. The “Bits” field can include various bits. For example, the Router Advertisement bit 8 can be the “N” flag, which can be assigned. This bit can be set by the AR to indicate that the access network supports network-based mobility management, i.e., PMIP6. Other bits can be available for further assignment.

The AR can include multiple IPv6 prefixes in a single RA message, with each prefix contained in an own Prefix Information Option. If the access network supports PMIP6, the AR can chose to simultaneously advertise local on-link IPv6 prefixes, as well as a specific PMIP6 prefix. For this specific case, the two different types of prefixes can be clearly differentiated.

In the PMIP6 domain, the AR can either advertise on-link prefixes or the PMIP6 prefix within the RA's Prefix Information Option. Assuming the MN is allowed PMIP6 service, the AR can advertise the individually assigned PMIP6 prefix as default, whereas one or more on-link prefixes can be included in the new PMIP6 Care-of Prefix option.

Mobile nodes that are capable of processing the new PMIP6 Care-of Prefix option can use obtained information according to preferences and internal configuration. If the MN is wishing to deploy host-based MIP6, the MN can use the prefix from the PMIP6 Care-of Prefix option and autoconfigure the MIP6 CoA. Otherwise, the MN can configure PMIP6 MN-HA from the Prefix Information Option. Nodes that are incapable of understanding the new option can ignore it.

TABLE 2
PMJP6 Care-of Prefix Option

```
  0 1 2 3
  0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+
| Type | Length | Prefix Length | Reserved1 |
+−+−+−+−+−+−+−+−+−+−+−+−+−+−+−+−+−+−+−+−+−+−+−+−+−+−+−+−+−+−+−+−+
| Valid Lifetime |
+−+−+−+−+−+−+−+−+−+−+−+−+−+−+−+−+−+−+−+−+−+−+−+−+−+−+−+−+−+−+−+−+
| Preferred Lifetime |
+−+−+−+−+−+−+−+−+−+−+−+−+−+−+−+−+−+−+−+−+−+−+−+−+−+−+−+−+−+−+−+−+
| Reserved2 |
+−+−+−+−+−+−+−+−+−+−+−+−+−+−+−+−+−+−+−+−+−+−+−+−+−+−+−+−+−+−+−+−+
| |
+ +
| |
+ PMIP6 Care-of Prefix +
| |
+ +
| |
+−+−+−+−+−+−+−+−+−+−+−+−+−+−+−+−+−+−+−+−+−+−+−+−+−+−+−+−+−+−+−+−+
```

As shown in table 2, the fields can include a “Type” field that is an 8-bit identifier for the PMIP6 Care-of Prefix option (to be assigned). The “Length” field can be 4. The “Prefix Length” can be an 8-bit unsigned integer, which can indicated the number of leading bits in the Prefix that are valid. The value can range from 0 to 128.

“Reserved1” can be a 6-bit unused field. This field can be initialized to zero by the sender and can be ignored by the receiver. The “Valid Lifetime” can be a 32-bit unsigned integer, which can correspond to the length of time in seconds (relative to the time the packet is sent) that the prefix is valid for the purpose of on-link determination. A value of all “one” bits (0xffffffff) can represent infinity. The Valid Lifetime can also used by [RFC2462].

The “Preferred Lifetime” field can contain a 32-bit unsigned integer, which can correspond to the length of time in seconds (relative to the time the packet is sent) that addresses generated from the prefix via stateless address autoconfiguration remain preferred. A value of all “one” bits (0xffffffff) can represent infinity.

Like “Reserved1,” “Reserved2” can be an unused field that can be initialized to zero by the sender and ignored by the receiver. The “PMIP6 CoA Prefix” field can include an IP address or a prefix of an IP address indicated as the PMIP6 on-link prefix. The Prefix Length field can contain the number of valid leading bits in the prefix. The bits in the prefix after the prefix length can be reserved and consequently initialized to zero by the sender and ignored by the receiver. A router can omit sending a prefix option for the link-local prefix and a host can ignore such a prefix option.

The PMIP6 Care-of Prefix option can provide the host with an on-link prefix for stateless address autoconfiguration. The PMIP6 Care-of Prefix option can appear in Router Advertisement packets only and can be silently ignored for other messages.

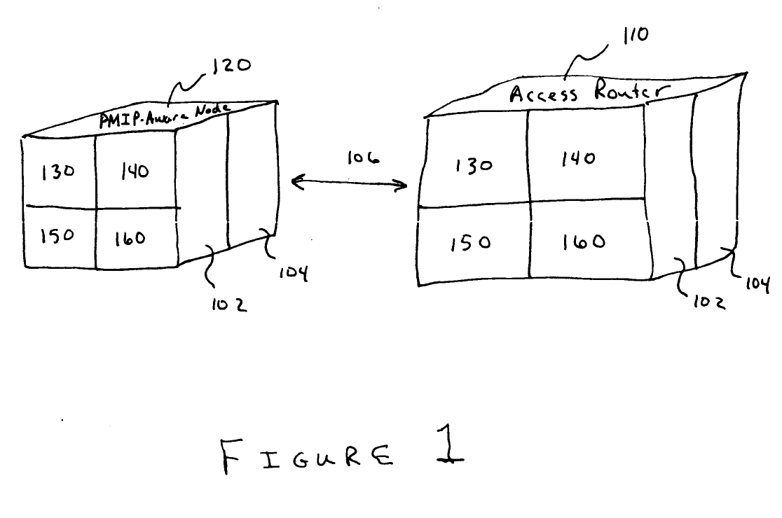

As illustrated in FIG. 1, a system can include an access router 110 and a proxy mobile internet protocol aware client mobile internet protocol node 120. The access router 110 can include a storage unit 130 configured to store a local care-of-address. The access router 110 can also include a sending unit 140 configured to send the proxy mobile internet protocol aware client mobile internet protocol node 120 the local care-of-address. The proxy mobile internet protocol aware client mobile internet protocol node 120 can include a receiving unit 150 configured to receive local care-of-address from an access router 110. The proxy mobile internet protocol aware client mobile internet protocol node 120 can also include a processing unit 160 configured to process the local care-of-address.

As shown in FIG. 1, each of the access router 110 and the protocol aware client mobile internet protocol node 120 can include a storage unit 130, a sending unit 140, a receiving unit 150, and a processing unit 160. Each of these units (130, 140, 150, and 160) can be implemented in software 102, hardware 104, or a combination thereof. The access router 110 and the protocol aware client mobile internet protocol node 120 can communicate with each over a communication link 106, which can be a wireless communication link. The hardware 104 can include, for example, a general purpose computer, an application specific integrated circuit, or a computer chip.

The sending unit 130 of the access router 110 can be configured to send the care-of-address in a router advertisement. The care-of-address can be configured to permit the proxy mobile internet protocol aware client mobile internet protocol node 120 to configure the care-of-address from the local address. The care-of-address can be configured to permit avoidance of double-tunneling by the proxy mobile internet protocol aware client mobile internet protocol node 120.

The receiving unit 150 of the protocol aware client mobile internet protocol node 120 can be configured to receive the care-of-address in a router advertisement. 11. The protocol aware client mobile internet protocol node 120 can be configured to configure the care-of-address from the local address. The protocol aware client mobile internet protocol node 120 can be configured to set up a session without double-tunneling while in a proxy mobile internet protocol environment.

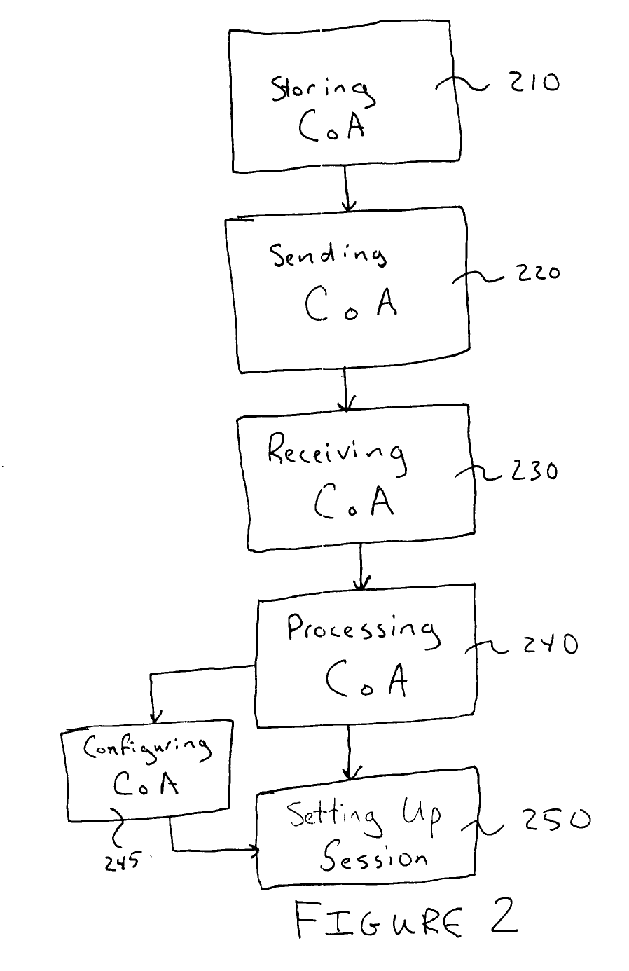

As illustrated in FIG. 2, a method can include storing a local care-of address 210 and sending a proxy mobile internet protocol aware client mobile internet protocol node the local care-of-address 220. The method can also include receiving the local care-of-address from an access router 230, and processing the local care-of-address 240. Additionally, the method can include configuring the care-of-address from the local address 245 and setting up a session without double-tunneling while in a proxy mobile internet protocol environment based on the care-of-address 250.

Such a method can be performed by the use of a computer program embodied on a computer-readable medium, encoding instructions for performing the various aspects of the method. The computer-readable medium can be an electronically programmable read only memory, a flash random access memory, a compact disc, or the like.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus, comprising:
a storage unit configured to store a local care-of-address; and
a sending unit configured to send a proxy mobile internet protocol aware client mobile internet protocol node the local care-of-address.

2. The apparatus of claim 1, wherein the apparatus comprises an access router.

3. The apparatus of claim 1, wherein the sending unit is configured to send the care-of-address in a router advertisement.

4. The apparatus of claim 1, wherein the care-of-address is configured to permit the proxy mobile internet protocol aware client mobile internet protocol node to configure the care-of-address from the local address.

5. The apparatus of claim 1, wherein the care-of-address is configured to permit avoidance of double-tunneling by the proxy mobile internet protocol aware client mobile internet protocol node.

6. An apparatus, comprising:
a receiving unit configured to receive a local care-of-address from an access router; and
a processing unit configured to process the local care-of-address.

7. The apparatus of claim 6, wherein the apparatus comprises a proxy mobile internet protocol aware client mobile internet protocol node.

8. The apparatus of claim 6, wherein the receiving unit is configured to receive the care-of-address in a router advertisement.

9. The apparatus of claim 6, wherein the care-of-address is configured to permit the apparatus to configure the care-of-address from the local address.

10. The apparatus of claim 6, wherein the care-of-address is configured to permit avoidance of double-tunneling by the apparatus

11. The apparatus of claim 6, wherein the apparatus is configured to configure the care-of-address from the local address.

12. The apparatus of claim 6, wherein the apparatus is configured to set up a session without double-tunneling while in a proxy mobile internet protocol environment.

13. A method, comprising:
storing a local care-of-address; and
sending a proxy mobile internet protocol aware client mobile internet protocol node the local care-of-address.

14. The method of claim 13, wherein the method is performed by an access router.

15. The method of claim 13, wherein the sending comprises sending the care-of-address in a router advertisement.

16. The method of claim 13, wherein the care-of-address is configured to permit the proxy mobile internet protocol aware client mobile internet protocol node to configure the care-of-address from the local address.

17. The method of claim 13, wherein the care-of-address is configured to permit avoidance of double-tunneling by the proxy mobile internet protocol aware client mobile internet protocol node.

18. A method, comprising:
receiving a local care-of-address from an access router; and
processing the local care-of-address.

19. The method of claim 18, wherein the method is performed by a proxy mobile internet protocol aware client mobile internet protocol node.

20. The method of claim 18, wherein the receiving comprises receiving the care-of-address in a router advertisement.

21. The method of claim 18, wherein the care-of-address is configured to permit the apparatus to configure the care-of-address from the local address.

22. The method of claim 18, wherein the care-of-address is configured to permit avoidance of double-tunneling by the apparatus.

23. The method of claim 18, further comprising:
configuring the care-of-address from the local address

24. The method of claim 18, further comprising:
setting up a session without double-tunneling while in a proxy mobile internet protocol environment based on the care-of-address.

25. A system, comprising:
an access router, comprising
a storage unit configured to store a local care-of-address, and
a sending unit configured to send the proxy mobile internet protocol aware client mobile internet protocol node the local care-of-address; and
the proxy mobile internet protocol aware client mobile internet protocol node, comprising
a receiving unit configured to receive the local care-of-address from the access router, and
a processing unit configured to process the local care-of-address.

26. An apparatus, comprising:
storage means for storing a local care-of-address; and
sending means for sending a proxy mobile internet protocol aware client mobile internet protocol node the local care-of-address.

27. An apparatus, comprising:
receiving means for receiving a local care-of-address from an access router; and
processing means for processing the local care-of-address.

28. A computer program embodied on a computer-readable medium encoding instructions for performing:
storing a local care-of-address; and
sending a proxy mobile internet protocol aware client mobile internet protocol node the local care-of-address.

29. A computer program embodied on a computer-readable medium encoding instructions for performing:
receiving a local care-of-address from an access router; and
processing the local care-of-address.
